(19) United States
(12) Patent Application Publication
(10) Pub. No.: US 2025/0266220 A1
(43) Pub. Date: Aug. 21, 2025

(54) KEY ASSEMBLY, CONTROLLER, AND INFORMATION PROCESSING SYSTEM

(71) Applicant: NINTENDO CO., LTD., Kyoto-shi (JP)

(72) Inventors: Masato KUWAHARA, Kyoto-shi (JP); Kochi KAWAI, Kyoto-shi (JP)

(21) Appl. No.: 19/201,485

(22) Filed: May 7, 2025

Related U.S. Application Data
(63) Continuation of application No. PCT/JP2022/042407, filed on Nov. 15, 2022.

(51) Int. Cl. H01H 13/14; H01H 13/20

(52) U.S. Cl. CPC H01H 13/14; H01H 13/20

(57) ABSTRACT

A key assembly includes; a substrate having an electrode and at least two contacts on an upper surface, which is a surface on a first direction side, thereof; a moving part arranged on the first direction side of the substrate and being non-conductive; and a first conductor electrically connected to the electrode. The moving part includes a first surface spaced from and facing the upper surface in a natural state, a second surface provided on a side opposite of the first surface, and a through hole penetrating the moving part in the first direction between the first and second surfaces. A second conductor is provided on the first surface at a position which contacts the contacts simultaneously when the moving part moves from the natural state in a second direction opposite to the first direction. The first conductor extends to the second surface through the through hole.

### CROSS-REFERENCE TO RELATED APPLICATION

The present application is a continuation of International Patent Application No. PCT/JP2022/042407 filed on Nov. 15, 2022, which is incorporated herein by reference in their entirety.

### FIELD

The present disclosure relates to a key assembly, a controller, and an information processing system including the key assembly.

### BACKGROUND

Key assemblies which include a plurality of contacts arranged on a substrate and a conductor arranged to face these contacts, and which are configured to detect the presence or absence of electrical continuity between the contacts when the conductor comes into contact with both contacts, have conventionally been known (for example, JP 2012-129214 A).

### SUMMARY

In the key assembly described in JP 2012-129214 A, though the presence or absence of pressing of the key assembly can be detected by detecting the presence or absence of electrical continuity between the contacts due to the conductor coming into contact with both contacts, it is not possible to detect whether an object such as a finger of a user approaches or touches the key assembly. Furthermore, in order to enable detection of whether an object such as a finger of a user approaches or touches the key assembly, the structure of the key assembly may be complicated.

The gist of the present disclosure is as follows.

(1) A key assembly, comprising:

a substrate comprising an electrode and at least two contacts on an upper surface, which is a surface on a first direction side, thereof,

a moving part which is arranged on the first direction side of the substrate and which is non-conductive, and

a first conductor which is electrically connected to the electrode, wherein

the moving part comprises a first surface which is spaced from and faces the upper surface of the substrate in a natural state, a second surface which is provided on a side opposite of the first surface, and a through hole which penetrates the moving part in the first direction between the first surface and the second surface,

a second conductor is provided on the first surface of the moving part at a position which contacts the at least two contacts simultaneously in response to a movement of the moving part from the natural state in a second direction opposite to the first direction, and

the first conductor extends to the second surface through the through hole.

(2) The key assembly according to above (1), wherein the first conductor comprises an elastic member which biases an end of the first conductor on the second direction side in the first direction.

(3) The key assembly according to above (1) or (2), wherein the first conductor covers the second surface of the moving part.

(4) The key assembly according to above (3), wherein the first conductor covers an entirety of the second surface of the moving part.

(5) The key assembly according to above (3) or (4), wherein the first conductor comprises an upper body which covers the second surface and which is rigid.

(6) The key assembly according to above (5), wherein the first conductor comprises a lower body which is provided between the substrate and the upper body and which biases the upper body in the first direction.

(7) The key assembly according to above (6), wherein the upper body is partially positioned in the through hole of the moving part.

(8) The key assembly according to above (7), wherein a portion of the upper body which is positioned in the through hole is in radial contact with an inner surface of the moving part, which defines the through hole.

(9) The key assembly according to above (8), wherein the lower body is a coil spring and is arranged so as to surround a periphery of a portion of the upper body on the second direction side more than a portion of the upper body in contact with the inner surface of the moving part.

(10) The key assembly according to any one of above (6) to (9), further comprising an clastic member which comprises the moving part and a biasing part which biases the moving part in the first direction toward a position in the natural state when the moving part moves from the natural state in the second direction, wherein

when the moving part moves from the natural state in the second direction, a force by which the biasing part biases the moving part in the first direction is greater than a force by which the lower body biases the upper body in the first direction.

(11) The key assembly according to any one of above (3) to (10), wherein at least one of the at least contacts is connected to a ground, and the moving part is formed such that a distance between the first surface and the second surface decreases as a pressing force increases when the first conductor is pressed in the second direction after the second conductor has come into contact with the at least two contacts.

(12) The key assembly according to above (11), wherein at least one of the at least two contacts is connected to a ground, and the first conductor is arranged on the first direction side of the second conductor so as to at least partially overlap the second conductor when viewed in the first direction.

(13) The key assembly according to any one of above (1) to (12), wherein the second conductor extends so as to surround the through hole.

(14) The key assembly according to above (12), wherein two of the contacts are provided on the substrate, and two of the contacts are arranged so as to be co-annular and positioned radially inward and radially outward relative to each other.

(15) The key assembly according to any one of above (1) to (14), further comprising a key top which is provided further on the first direction side than the moving part and the first conductor, wherein the key top is adhered to a surface of the first conductor on the first direction side via an adhesive, and at least one of the key top and the adhesive is non-conductive.

(16) The key assembly according to any one of above (1) to (15), wherein one of the two contacts is connected to a ground, and the first conductor is arranged on a first direction side of the contact which is connected to the ground so as to at least partially overlap the contact which is connected to the ground when viewed in the first direction.

(17) A controller, comprising the key assembly according to any one of above (1) to (16), and a detection circuit, wherein the detection circuit is configured so as to be capable of detecting a value of a parameter which changes in accordance with a presence or absence of current between the contacts and a capacitance of a circuit including the electrode.

(18) A controller, comprising the key assembly according to above (11) or (12) and a detection circuit, wherein

the detection circuit is configured so as to be capable of detecting a capacitance which changes in accordance with a distance between the second conductor, which is in contact with the contact which is connected to the ground, and the first conductor.

(19) An information processing system, comprising the key assembly according to any one of above (1) to (16), and one or a plurality of processors, wherein the processors perform processing based on a value of a parameter which changes in accordance with a presence or absence of current between the contacts and a capacitance of a circuit including the electrode.

### BRIEF DESCRIPTION OF DRAWINGS

Embodiments of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a key assembly taken along a cross section passing through an axis of the key assembly.

FIG. 2 is an exploded perspective view of the key assembly.

FIG. 3 is a plan view of a substrate.

FIG. 4 is a plan view of the substrate.

FIG. 5 is a view schematically detailing the substantial circuit configuration of a controller including the key assembly.

FIG. 6 is a cross-sectional view of the key assembly similar to FIG. 1, when a finger approaches a key top.

FIG. 7 is a view similar to FIG. 5, schematically showing a substantial circuit configuration, when a finger approaches the key top as shown in FIG. 6.

FIG. 8 is a cross-sectional view of the key assembly 1 similar to FIG. 1, when a finger presses the key top downward and a conductor comes into contact with contacts.

FIG. 9 is a view similar to FIG. 5, schematically showing a substantial circuit configuration, when the conductor touches the contacts as shown in FIG. 8.

FIG. 10 is a cross-sectional view of the key assembly 1 similar to FIG. 1, when the key top is pressed to a bottom-most end.

FIG. 11 is a view showing the relationship between a position of the finger of a user and the presence or absence of capacitance and conduction between the contacts.

FIG. 12 is a view schematically showing the system configuration of an information processing system including a controller.

FIG. 13 is a cross-sectional view similar to FIG. 1, showing a key assembly according to a modified example.

FIG. 14 is a cross-sectional view similar to FIG. 1, showing a key assembly according to a modified example.

### DESCRIPTION OF EMBODIMENTS

The embodiments will be described in detail with reference to the drawings. In the following description, identical elements have been assigned the same reference signs.

### Key Assembly Configuration

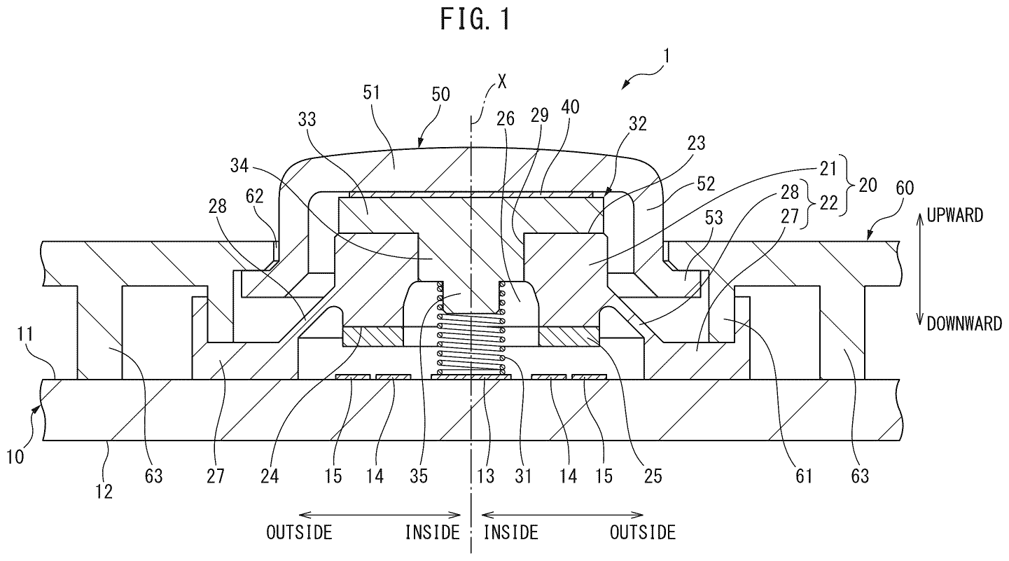

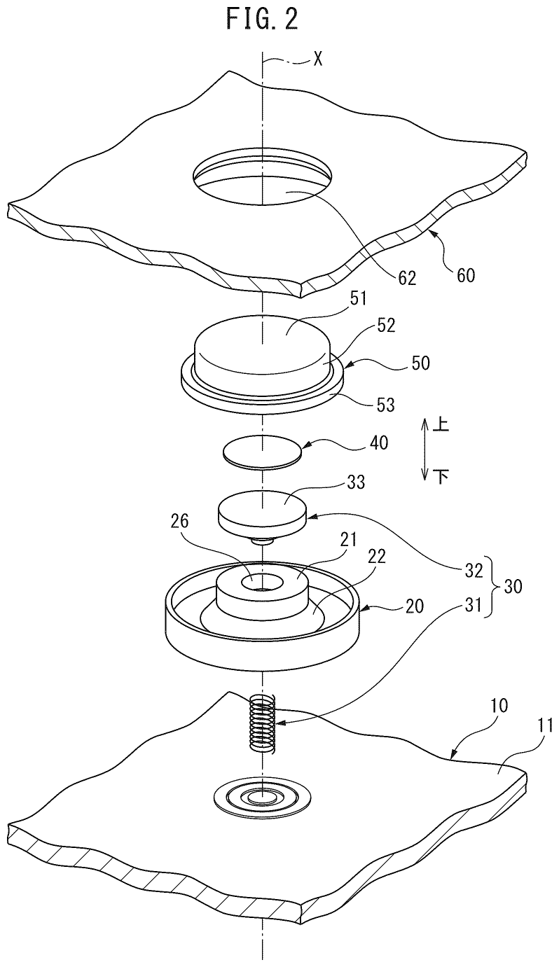

The overall configuration of a key assembly 1 provided in a controller according to an embodiment will be described with reference to FIGS. 1 and 2. The controller having the key assembly 1 is configured to output a signal in response to a key operation by a user. In particular, in the present embodiment, the controller is configured to detect whether the key assembly 1 is pressed by the user, the degree by which an object for operating the key assembly 1 (for example, the finger of the user) is approaching the key assembly 1 when a finger of a user is approaching the key assembly 1, and the degree by which the key assembly 1 is pressed.

FIG. 1 is a cross-sectional view of the key assembly 1 taken along a cross-section passing through an axis X of the key assembly 1. FIG. 2 is an exploded perspective view of the key assembly 1. As shown in FIGS. 1 and 2, the key assembly 1 includes a substrate 10, an elastic member 20, a conductive assembly 30, an adhesive 40, a key top 50, and a cover 60. As shown in FIGS. 1 and 2, the elastic member 20, the conductive assembly 30, the adhesive 40, and the key top 50 are arranged so as to overlap each other such that the centers thereof are positioned on the axis X.

In the present description, the direction from the substrate 10 to the key top 50 along the axis X is referred to as the upward direction, and the direction from the key top 50 to the substrate 10 (i.e., the direction opposite to the upward direction) is referred to as the downward direction. Note that the upward and downward directions are used for convenience of explanation, and the key assembly I need not necessarily be used in the manner wherein the upward direction corresponds to the vertical upward direction, and the key assembly 1 can be used in any direction. Thus, the key assembly 1 can be used, for example, such that the axis X extends horizontally, or such that the axis X extends in various different directions during use. Therefore, the upward direction can be considered as a first direction, and the downward direction can be considered as a second direction opposite to the first direction. Furthermore, the direction perpendicular to the axis X radially away from the axis X is referred to as the outward direction, and the direction perpendicular to the axis X toward the axis X (i.e., the direction opposite to the outward direction) is referred to as the inward direction. Furthermore, in the present description, a state in which no external forces are applied to the key assembly 1 by the finger of a user or the like is referred to as a natural state.

### Substrate

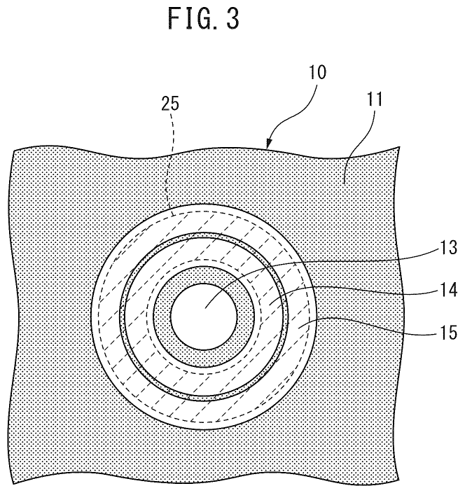

Next, the substrate 10 will be described with reference to FIGS. 1 to 3. FIG. 3 is a plan view of the substrate 10. The substrate 10 is a plate-like member on which electronic components are arranged. The substrate 10 is, for example, a printed circuit board. The substrate 10 may be a rigid substrate or may be an FPC. The substrate 10 has a substrate upper surface 11 provided on an upper side thereof, and a substrate lower surface 12 provided on a lower side thereof. Thus, the substrate lower surface 12 is a surface provided on a side opposite to the substrate upper surface 11.

In the present embodiment, as shown in FIGS. 1 to 3, one electrode 13 and two contacts 14, 15 are provided on the substrate upper surface 11. The one electrode 13 has a circular shape and is arranged such that the center thereof is positioned on the axis X. Note that the electrode 13 may have a shape other than a circle, and may be arranged so as to be offset from the axis X. However, the electrode 13 has a shape and is arranged so as to be capable of coming into contact with a coil spring 31 of a conductive assembly 30, which will be described later.

In the present embodiment, the contacts 14, 15 have an annular shape as shown in FIGS. 2 and 3. In the present embodiment, the contacts 14, 15 are arranged on the inner side and the outer side of each other. In particular, in the present embodiment, the contacts 14, 15 are formed in a concentric circle shape.

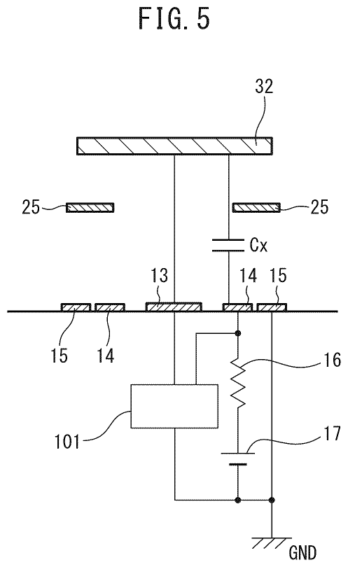

One of the contacts 14, 15 is connected to the ground, and the other is connected to a power source 17 (see FIG. 5), having a higher potential than the ground, via an electrical resistance 16 (refer to FIG. 5) (hereinafter, these are referred to as the ground contact 15 and the high potential contact 14, respectively). Thus, when a conductor 25 is in contact with both of the contacts 14, 15, a current flows from the high potential contact 14 to the ground contact 15. Though the inner contact is the high potential contact 14 and the outer contact is the ground contact 15 in the present embodiment, the high potential contact 14 and the ground contact 15 may be arranged in reverse, with the inner and outer sides reversed. The electrical resistance 16 and the power source 17 may be provided on the substrate 10, or may be provided on a member separate from the substrate 10.

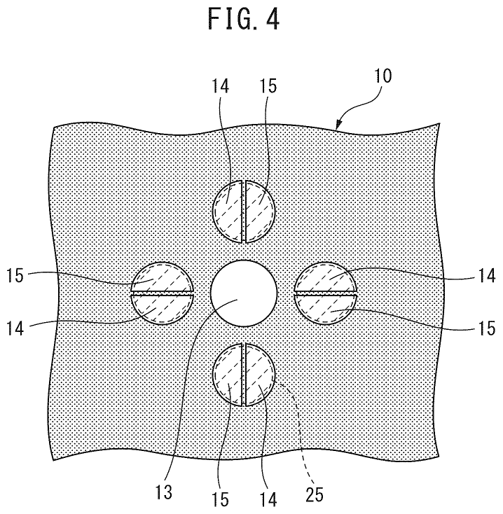

The contacts 14, 15 may be formed in a manner different from that of the present embodiment as long as they can be electrically connected by the conductor 25, which will be described later. Thus, the contacts 14, 15 may not be formed in a concentric shape, but may be formed in an annular shape such as an ellipse or a polygon such as a rectangle. The contacts 14, 15 may not be formed in an annular shape, but may be formed in any shape such as a semicircular shape as shown in FIG. 4. Though the two contacts 14, 15 are provided on the substrate upper surface 11 in the present embodiment, three or more contacts may be provided. In the example shown in FIG. 4, four pairs of semicircular high potential contacts 14 and semicircular ground contacts 15 are provided at 90° intervals in the circumferential direction, whereby a total of eight contacts are provided. Thus, at least two contacts are provided on the substrate upper surface 11.

When three or more contacts are provided, some of the contacts are formed as high potential contacts 14, and the remaining contacts are formed as ground contacts 15. The high potential contacts 14 and the ground contacts 15 are arranged adjacent to each other.

### Elastic Member

Next, the clastic member 20 will be described with reference to FIGS. 1 and 2. The elastic member 20 is formed of a non-conductive elastic material, for example, a synthetic rubber such as silicone rubber. The clastic member 20 is arranged on the upper side of the substrate 10. The clastic member 20 is arranged so that the axis thereof is positioned on the axis X of the key assembly 1.

The elastic member 20 includes a moving part 21 which moves in the upward and downward directions, and a biasing part 22 which is connected to the moving part 21. Both the moving part 21 and the biasing part 22 are arranged on the upper side of the substrate 10. In the present embodiment, the inner periphery of the biasing part 22 is connected to the outer periphery of the moving part 21. Though the moving part 21 and the biasing part 22 are integrally formed in the present embodiment, they may be formed as separate components.

The moving part 21 is a member which moves in the direction of the axis X, i.e., in the upward-downward directions, when the key assembly 1 (in particular, the key top 50) is pressed by an object such as a finger of a user. In particular, the moving part 21 is positioned at the uppermost position within the movable range when in a natural state. Conversely, the moving part 21 can move downward until the conductor 25, which is arranged below the moving part 21 and which moves together with the moving part 21, comes into contact with the substrate 10, and in particular, the contacts 14, 15 on the substrate 10.

The moving part 21 has a moving part upper surface 23 provided on the upper side, a moving part lower surface 24 provided on the lower side, and a through hole 26 extending through the moving part 21 in the upward-downward directions between the moving part upper surface 23 and the moving part lower surface 24. Thus, the moving part upper surface 23 is provided on the side of the moving part 21 opposite to the moving part lower surface 24. Furthermore, the through hole 26 is open in both the moving part upper surface 23 and the moving part lower surface 24. In the present embodiment, the through hole 26 is formed so that the axis thereof is positioned on the axis X of the key assembly 1. Furthermore, in the present embodiment, the moving part 21 is solidly formed except for the through hole 26.

In the present embodiment, the moving part upper surface 23 is formed so that the center thereof is positioned on the axis X. Likewise, the moving part lower surface 24 is formed so that the center thereof is positioned on the axis X. In the present embodiment, both the moving part upper surface 23 and the moving part lower surface 24 have a circular shape. However, the moving part upper surface 23 and the moving part lower surface 24 may have any shape other than circular.

The moving part lower surface 24 is arranged so as to be spaced apart from the substrate upper surface 11 in the natural state and so as to face the substrate upper surface 11. In particular, in the present embodiment, the moving part lower surface 24 is arranged so as to be parallel to the substrate upper surface 11 in the natural state.

Furthermore, the moving part 21 is formed of an elastic material. Thus, when a force is applied between the moving part upper surface 23 and the moving part lower surface 24, the moving part 21 is compressed such that the distance between the moving part upper surface 23 and the moving part lower surface 24 decreases as the force increases. In particular, the moving part 21 is formed of an elastic material which can be compressed while maintaining contact between the conductor 25 and the contacts 14, 15 when the moving part upper surface 23 is pressed downward after the conductor 25 comes into contact with the contacts 14, 15. Moreover, the moving part 21 may be formed of a material having a high relative permittivity.

Furthermore, as shown in FIG. 1, a flat conductor 25 is arranged on the moving part lower surface 24. The conductor 25 is affixed to the moving part lower surface 24 by any means such as an adhesive, and moves along with the movement of the moving part 21. The conductor 25 is an example of a second conductor provided on the moving part lower surface 24. The conductor 25 is formed of an electrically conductive material, such as a metal or a carbon-based material. Note that the conductor 25 need not be a flat member affixed to the moving part lower surface 24 by an adhesive or the like, as long as it is a conductive material arranged on the moving part lower surface 24. Thus, for example, the conductor 25 may be a conductive coating applied to the moving part lower surface 24.

The conductor 25 extends around the through hole 26 so as to surround the through hole 26. In particular, in the present embodiment, the conductor 25 has a shape which is substantially identical to the shape of the moving part lower surface 24 (a toroidal shape excluding the opening of the through hole 26). Thus, the conductor 25 is formed so as to cover the entire moving part lower surface 24. Since the conductor 25 covers the entire moving part lower surface 24 in this manner, the corner between the upper surface and the outer peripheral surface of the conductor 25 is not positioned on the moving part lower surface 24, whereby the exertion of a large load on a part of the moving part lower surface 24 by such a corner is suppressed. The conductor 25 may be formed so as to cover the entire moving part lower surface 24 and so as to be larger than the moving part lower surface 24. Alternatively, the conductor 25 may be formed so as to be smaller than the moving part lower surface 24.

Furthermore, the conductor 25 is formed so as to overlap both of the two contacts 14, 15 when viewed in the upward-downward direction. In particular, in the present embodiment, as indicated by the dashed line in FIG. 3, the conductor 25 has an inner diameter which is smaller than the outer shape of the inner contact 14 and an outer diameter which is larger than the inner diameter of the outer contact 15. Further, in the present embodiment, the conductor 25 is arranged above the ground contact 15, and the distance between the conductor 25 and the ground contact 15 changes in accordance with the movement of the moving part 21 in the upward-downward directions. When the moving part 21 moves downward to its limit, the conductor 25 comes into contact with both contacts 14, 15 simultaneously, and as a result, the two contacts 14, 15 are electrically connected to each other.

In the example shown in FIG. 4, four conductors 25 are provided so as to overlap the respective pairs of contacts 14, 15 when viewed in the upward-downward directions. Each conductor 25 is formed to have the same radius as the semicircular contacts 14, 15. In the example shown in FIG. 4, when the moving part 21 moves downward to its limit, cach conductor 25 contacts both contacts 14, 15 simultaneously, and as a result, conduction is established between the contacts 14, 15. When the moving part 21 moves downward while the moving part lower surface 24 is inclined, one or more of the four conductors 25 may contact both contacts 14, 15 simultaneously.

The conductor 25 may be provided in any manner as long as it contacts both contacts 14, 15 simultaneously when the moving part 21 moves downward. Thus, it may be provided separately at two locations around the through hole 26 on both sides of the through hole 26, or it may be provided at only one location around the through hole 26. Furthermore, when the conductor 25 is formed of an elastic material, it need not necessarily be provided at a position where it overlaps both contacts 14, 15 when viewed in the upward-downward directions when the conductor 25 is not in contact with the contacts 14, 15, as long as it is in a position where it contacts both contacts 14, 15 when the moving part 21 moves downward and the conductor 25 is compressed between the contacts 14, 15 and the moving part lower surface 24, causing the surface area thereof to expand.

The biasing part 22 biases the moving part 21 toward a position in the natural state when the moving part 21 moves downward from the natural state. The biasing part 22 includes a base part 27 arranged on the substrate upper surface 11 and a skirt part 28 extending between the moving part 21 and the base part 27.

The base part 27 is arranged on the substrate upper surface 11 so as not to move. In particular, in the present embodiment, the base part 27 is interposed between the substrate 10 and a guide member 61 of the cover 60, and is affixed to the substrate upper surface 11 by the substrate 10 and the guide member 61 so as not to move. Note that this affixation method is one example, and any appropriate method can be adopted.

The skirt part 28 is a plate-like member having a truncated conical shape, and the upper circular edge thereof is connected to the outer periphery of the moving part 21, while the lower circular edge thereof is connected to the base part 27. The skirt part 28 deforms when the moving part 21 moves downward from the natural state, and biases the moving part 21 upward by the elastic force thereof.

### Conductive Assembly

Next, the conductive assembly 30 will be described with reference to FIGS. 1 and 2. The conductive assembly 30 is an example of a first conductor which is electrically connected to the electrode 13 of the substrate 10. The conductive assembly 30 is used to detect the degrees to which an object such as a finger of a user is approaching the key assembly 1 and the degree to which the key assembly is being pressed.

As shown in FIGS. 1 and 2, the conductive assembly 30 includes a coil spring 31 which is arranged on the relatively lower side and a conductive member 32 which is arranged on the relatively upper side. The conductive member 32 is an example of an upper body which is arranged so as to cover the moving part upper surface 23. The conductive member 32 is arranged on the relatively upper side in the conductive assembly 30. The coil spring 31 is an example of a lower body which is provided between the substrate 10 and the conductive member 32, which is the upper body. The conductive assembly 30 is formed of a conductive material, such as a metal. Alternatively, the conductive assembly 30 may be formed by providing a conductive coating on a non-conductive material such as a resin, or by providing a non-conductive material on a conductive material.

The coil spring 31 is arranged so that the axis thereof is positioned on the axis X of the key assembly 1. The coil spring 31 is also positioned on the electrode 13 and in contact with the electrode 13. In particular, the coil spring 31 is constantly in contact with the electrode 13 due to the clastic force of the coil spring 31. Thus, the coil spring 31 is electrically connected to the electrode 13. When the conductive member 32 is positioned lower than in the natural state thereof, the coil spring 31 is arranged between the substrate 10 and the conductive member 32 and biases the conductive member 32 upward with respect to the substrate 10. Thus, the coil spring 31 biases the upper end of the conductive assembly 30 upward.

In the present embodiment, the coil spring 31 is formed so that when the conductive member 32 and the moving part 21 move downward from the natural states thereof, the force with which the coil spring 31 biases the conductive member 32 upward is less than the force with which the biasing part 22 biases the moving part 21 upward. When the biasing force of the coil spring 31 is greater than the biasing force of the biasing part 22, the conductive member 32 biased by the coil spring 31 will be moved upward faster than the moving part 21 biased by the biasing part 22. As a result, the conductive member 32 and the moving part 21 may separate in the upward-downward directions. Conversely, since the biasing force of the coil spring 31 is less than the biasing force of the biasing part 22 in the present embodiment, the conductive member 32 and the moving part 21 are prevented from separating in the upward-downward directions.

The coil spring 31 may be affixed to the electrode 13 by, for example, solder or the like. Furthermore, another elastic member may be used as the lower body in place of the coil spring 31. As such another member, for example, a conductive elastic member which can be electrically connected to the electrode 13 and biases the conductive member 32 upward can be used.

The conductive member 32 has a higher rigidity than the other components, and in particular, than the elastic member 20. In particular, the conductive member 32 has a rigidity such that it will not deform even if the key assembly 1 is pressed by a finger of a user or the like. The conductive member 32 is arranged so that the axis thereof is positioned on the axis X of the key assembly 1. The conductive member 32 has a disk-shaped plate-like part 33, an intermediate part 34 having a smaller outer diameter than the plate-like part 33, and a protruding part 35 having a smaller outer diameter than the intermediate part 34. The intermediate part 34 is provided above the protruding part 35, and the plate-like part 33 is provided above the intermediate part 34. The plate-like part 33, the intermediate part 34, and the protruding part 35 are formed as an integral member.

The plate-like part 33 is arranged on the moving part upper surface 23. In the present embodiment, the plate-like part 33 has a shape which is substantially the same as the shape (circular shape) of the moving part upper surface 23. Thus, the plate-like part 33 is formed so as to cover the entire moving part upper surface 23. By covering the entire moving part upper surface 23 with the plate-like part 33 of the conductive assembly 30 in this manner, the corner between the lower surface and the outer circumferential surface of the plate-like part 33 is prevented from being positioned on the moving part upper surface 23, whereby the application of a large load on a part of the moving part upper surface 23 by such a corner is suppressed. The plate-like part 33 may be formed so as to cover the entire moving part upper surface 23 and to protrude radially outward from the moving part upper surface 23. Alternatively, the plate-like part 33 may be formed so as to be smaller than the moving part upper surface 23 while covering the moving part upper surface 23.

Furthermore, the plate-like part 33 is arranged above the conductor 25 so as to overlap the entire conductor 25 when viewed in the upward-downward directions. In particular, the plate-like part 33 is arranged above the conductor 25 with the moving part 21 interposed therebetween. Thus, the plate-like part 33 is arranged from the conductor 25 at a distance corresponding to the thickness of the moving part 21 in the upward-downward directions. Note that the plate-like part 33 may be arranged so as to partially overlap or so as not to overlap the conductor 25 when viewed in the upward-downward directions.

Furthermore, the plate-like part 33 is arranged above the ground contact 15 so as to overlap the entire ground contact 15 when viewed in the upward-downward directions. Thus, the plate-like part 33 is arranged above the ground contact 15 with the moving part 21 and the conductor 25 interposed therebetween. Note that the plate-like part 33 may be arranged so as to partially overlap or so as not to overlap the ground contact 15 when viewed in the upward-downward directions.

The intermediate part 34 and the protruding part 35 are positioned in the through hole 26 of the moving part 21. Thus, the conductive member 32 is partially positioned in the through hole 26. By positioning the rigid conductive member 32 in the moving part 21 in this manner, misalignment and shape change of the moving part 21 and the elastic member 20 including the moving part 21 can be suppressed. In the present embodiment, the intermediate part 34 has a cylindrical shape, and is formed so that the outer periphery thereof contacts the inner surface 29 of the moving part 21 that defines the through hole 26 over the entire circumference in the radial direction. In particular, the intermediate part 34 may be formed so that the outer diameter thereof is slightly larger than the inner diameter of the inner surface 29 of the moving part 21. In this case, the intermediate part 34 is fitted into the through hole 26. This allows the moving part 21 and the conductive member 32 to be positioned relative to each other.

The protruding part 35 has a cylindrical shape, and the coil spring 31 is arranged so as to surround the outer periphery of the protruding part 35. Thus, the coil spring 31 is positioned with respect to the conductive member 32 by the protruding part 35.

Furthermore, the conductive member 32 is arranged so that the axis thereof is positioned on the axis X of the key assembly 1. Therefore, the conductive member 32 is positioned above the coil spring 31, and thus comes into contact with the coil spring 31. In particular, the upper end of the coil spring 31 comes into contact with the lower surface of the intermediate part 34 around the protruding part 35. In the present embodiment, the conductive member 32 is constantly in contact with the coil spring 31 due to the elastic force of the coil spring 31. Therefore, the conductive member 32 is electrically connected to the coil spring 31. That is, the entire conductive assembly 30 including the coil spring 31 and the conductive member 32 is electrically connected to the electrode 13. The coil spring 31 may be affixed to the conductive member 32 by, for example, soldering or the like.

As a result of being constructed as described above, the conductive assembly 30 is electrically connected to the electrode 13 and extends to the moving part upper surface 23 through the through hole 26.

### Adhesive

The adhesive 40 adheres the key top 50 to the conductive member 32 of the conductive assembly 30. In particular, the adhesive 40 adheres the lower surface of the key top 50 to the upper surface of the plate-like part 33 of the conductive member 32. Thus, the key top 50 is adhered to the upper surface of the conductive member 32 via the adhesive 40. As a result, the key top 50 moves integrally with the conductive member 32. Since the conductive member 32 is affixed to the moving part 21 by engagement and the conductor 25 is affixed to the moving part 21 by the adhesive, the key top 50, the conductive member 32, the moving part 21, and the conductor 25 move integrally.

Any material having adhesive strength can be used as the adhesive 40. The adhesive 40 is also formed of a non-conductive material.

### Key Top

The key top 50 is the part of the key assembly 1 that is directly operated by the user. The key top 50 is formed of a non-conductive material, for example, a resin such as polyacetal. The key top 50 is provided above the elastic member 20 including the moving part 21 and the conductive assembly 30. The key top 50 is arranged so that the axis thereof is positioned on the axis X of the key assembly 1.

The key top 50 includes a circular upper wall 51, a cylindrical side wall 52, and a flange 53. The upper end of the cylindrical side wall 52 is connected to the outer periphery of the upper wall 51. The flange 53 extends outward from the lower end of the side wall 52.

The key top 50 is arranged so that the side wall 52 is positioned within an opening 62 formed in the cover 60. The outer diameter of the side wall 52 is smaller than the outer diameter of the opening 62. Thus, the key top 50 can move up and down within the opening 62. The flange 53 is formed so that the outer diameter thereof is larger than the outer diameter of the opening 62. As a result, the flange 53 cannot move upward beyond the opening 62. Thus, even if the moving part 21 and the conductive member 32 are biased upward and the key top 50 is biased upward accordingly, the key top 50 cannot move upward beyond the state where the flange 53 contacts the lower surface of the cover 60. In the present embodiment, the state where the key top 50 is biased upward and the flange 53 contacts the lower surface of the cover 60 is the natural state.

### Cover

The cover 60 constitutes a part of the housing which accommodates the components of the key assembly 1. The cover 60 is formed of a material such as resin. The cover 60 includes a guide member 61 for guiding the key top 50 so as to move in the upward-downward directions, an opening 62 through which the key top 50 moves, and an affixation part 63 which extends to the substrate 10.

The guide member 61 is formed in an annular shape so as to at least partially surround the flange 53 and extends in the upward-downward directions. The guide member 61 is formed so that the inner surface thereof is positioned outwardly of the outer periphery of the flange 53. The guide member 61 is formed so as to guide the outer peripheral surface of the flange 53 in the upward-downward directions.

The affixation part 63 is used to affix the cover 60 to the substrate 10. Thus, when the key assembly 1 is assembled, the lower end of the affixation part 63 comes into contact with the substrate upper surface 11, thereby affixing the cover 60 to the substrate 10. Note that any fastener such as a bolt may be used to affix the cover 60 to the substrate 10.

### Operation

Next, the operation of the key assembly 1 and the signals output from the key assembly 1 will be described with reference to FIGS. 5 to 11. FIG. 5 is a view schematically detailing the substantial circuit configuration of the controller including the key assembly 1.

As shown in FIG. 5, the controller includes a detection circuit 101 for detecting capacitance between the ground and the conductive member 32 and detecting continuity between the contacts 14, 15. The detection circuit 101 is connected to the conductive member 32 via the electrode 13 of the substrate 10 to detect capacitance. Furthermore, the detection circuit 101 is connected to the wiring between the high potential contact 14 and the electrical resistance 16 to detect the voltage at the high potential contact 14. The voltage at the high potential contact 14 is used to determine the continuity between the contacts 14, 15. The detection circuit 101 is further connected to the ground contact 15.

As shown in FIG. 5, in a state in which the key assembly 1 is in the natural state and an object such as a finger is not approaching the conductive member 32, the plate-like part 33 of the conductive member 32 is arranged above the ground contact 15 so as to face the ground contact 15 with the conductor 25 interposed therebetween. Thus, a capacitance Cx is generated between the conductive member 32 and the ground contact 15. Therefore, the capacitance Ct generated between the ground and the conductive member 32 is equal to the capacitance Cx generated between the conductive member 32 and the ground contact 15.

In this state, the high potential contact 14 is not electrically connected to the ground contact 15, and thus, the electric potential of the high potential contact 14 is maintained at a high level. Therefore, at this time, the voltage at the high potential contact 14 detected by the detection circuit 101 is higher than a predetermined reference voltage.

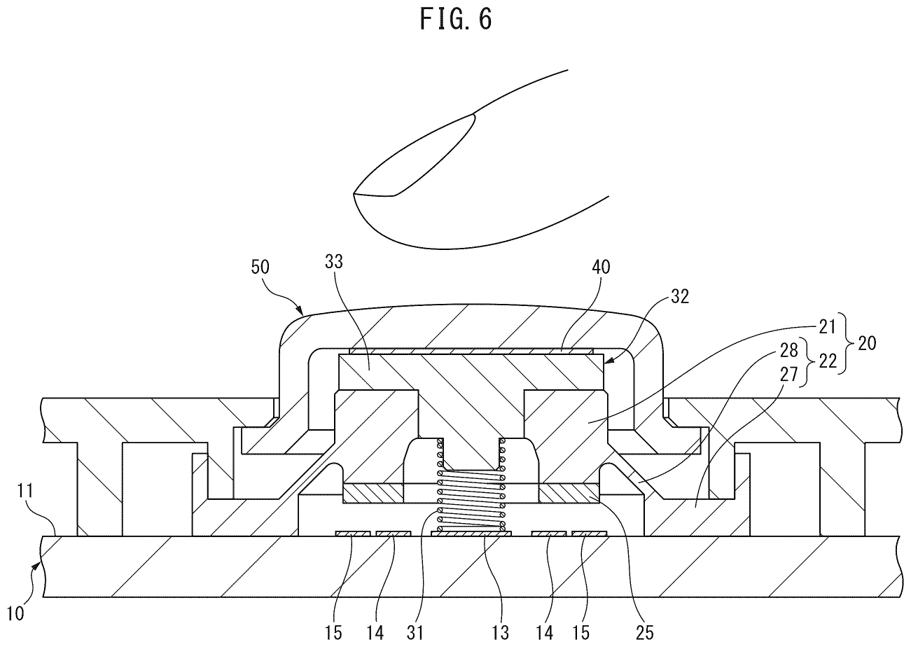

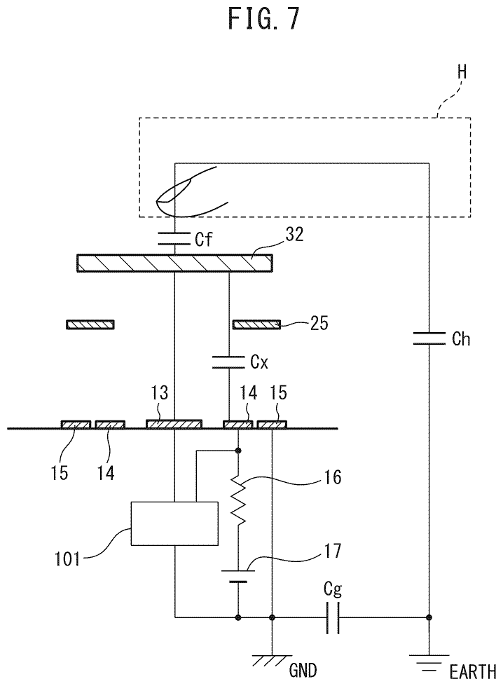

FIG. 6 is a cross-sectional view of the key assembly 1 similar to FIG. 1, when a finger approaches the key top 50. Furthermore, FIG. 7 is a view similar to FIG. 5, schematically showing the substantial circuit configuration when a finger approaches the key top 50 as shown in FIG. 6.

As shown in FIG. 7, when a finger approaches the key top 50, a capacitance Cf is generated between the finger and the conductive member 32 due to the finger. Furthermore, a capacitance Ch is generated between the human body including the finger and the earth. Thus, the capacitance Ct generated between the ground and the conductive member 32 can be expressed by the following formula (1):

Ct=Cx+1/Cf+1/Ch+1/Cg (1)

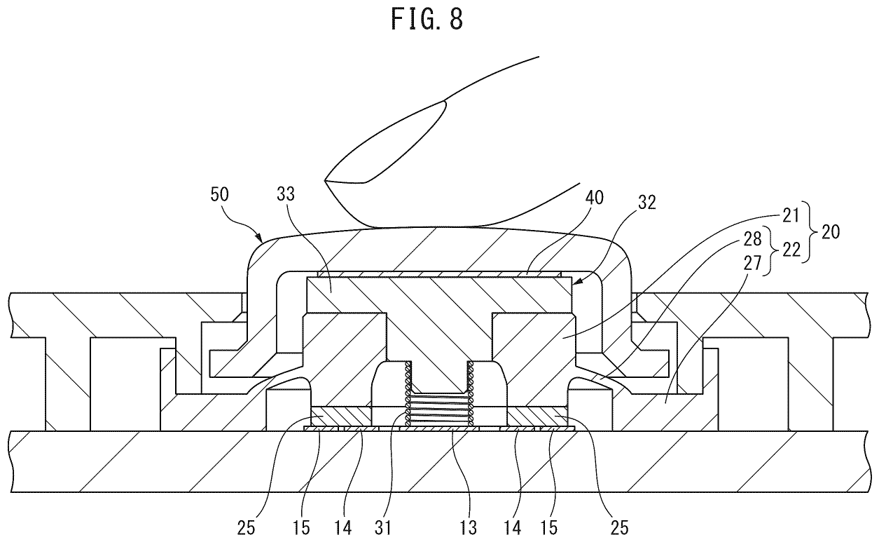

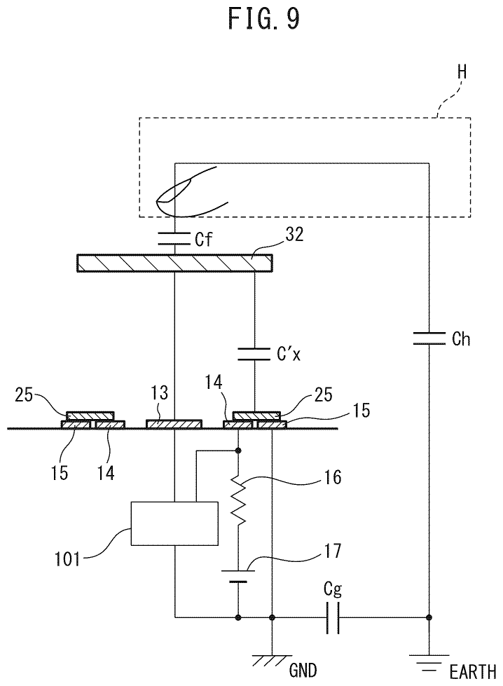

FIG. 8 is a cross-sectional view of the key assembly 1 similar to FIG. 1, when a finger presses the key top 50 downward and the conductor 25 comes into contact with the contacts 14, 15. FIG. 9 is a view similar to FIG. 5, schematically showing the substantial circuit configuration when the conductor 25 comes into contact with the contacts 14, 15 as shown in FIG. 8.

As shown in FIG. 9, when the conductor 25 comes into contact with the ground contact 15, the conductor 25 is connected to the ground. In particular, the plate-like part 33 of the conductive member 32 is arranged above the conductor 25 connected to the ground contact 15 so as to face the conductor 25, and thus, a capacitance C′x is generated between the conductive member 32 and the conductor 25. Therefore, the capacitance Ct generated between the ground and the conductive member 32 can be expressed by the following formula (2):

Ct=C′x+1/Cf+1/Ch+1/Cg (2)

Furthermore, when the conductor 25 comes into contact with the ground contact 15, it also comes into contact with the high potential contact 14 at substantially the same time. Thus, the high potential contact 14 is conductive with the ground contact 15, and as a result, the electric potential of the high potential contact 14 becomes low. Thus, at this time, the voltage at the high potential contact 14 detected by the detection circuit 101 is lower than a predetermined reference voltage. In this manner, the voltage at the high potential contact 14 is a parameter which changes in accordance with the presence or absence of conductivity between the contacts 14, 15, and thus, it can be said that the detection circuit 101 detects the value of a parameter which changes in accordance with the presence or absence of conductivity between the contacts 14, 15.

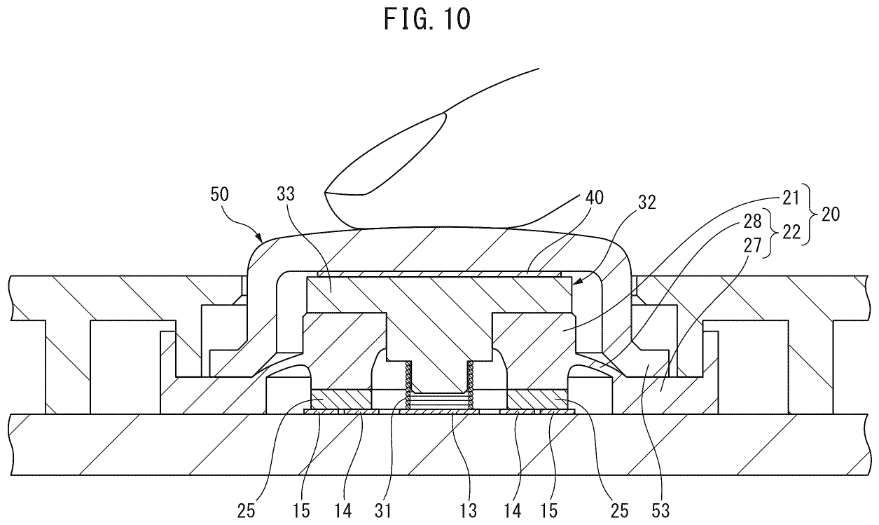

Thereafter, when the finger presses the key top 50 further downward, and specifically, when the conductive member 32 is pressed downward, the moving part 21 is deformed so as to be compressed in the upward-downward directions. Specifically, the moving part 21 is formed so that when the conductive member 32 is pressed downward after the conductor 25 comes into contact with both contacts 14, 15, the greater the pressing force, the smaller the distance between the moving part upper surface 23 and the moving part lower surface 24 becomes. As a result, as the key top 50 moves downward, the distance between the plate-like part 33 of the conductive member 32 and the conductor 25 in contact with the ground contact becomes shorter. Finally, as shown in FIG. 10, the key top 50 is pressed down until the flange 53 of the key top 50 comes into contact with the base part 27 of the elastic member 20.

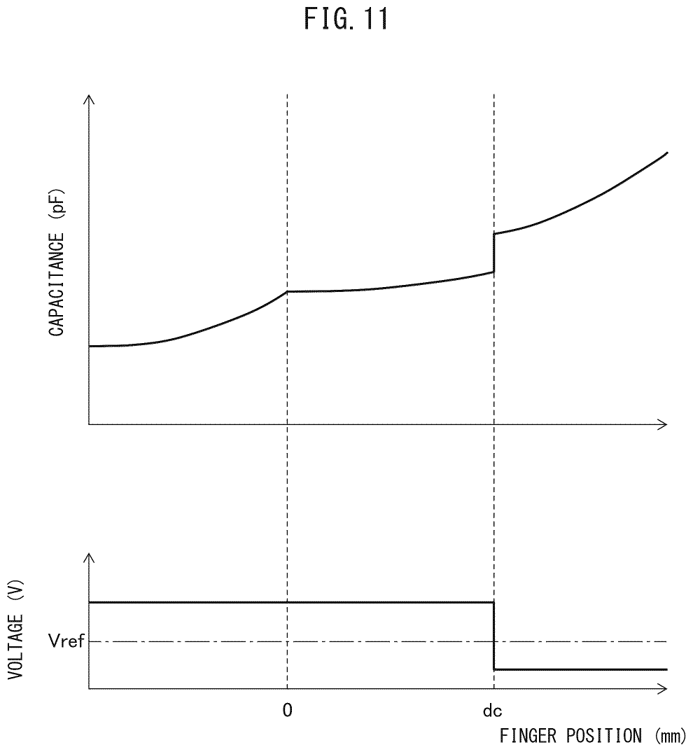

FIG. 11 is a view showing the relationship between the position of the finger of a user, which is the object that operates the key assembly 1, and the capacitance between the conductive member 32 and ground detected by the detection circuit 101, and the voltage at the high potential contact 14. The finger position is represented as zero when the finger touches the key top 50, and the value of the finger position increases as the finger moves downward. Thus, when the finger is not in contact with the key top 50 and is spaced from the key top 50, the value of the finger position is negative, and when the finger is in contact with the key top 50 and pressing it down, the value of the finger position is positive.

When the key assembly 1 is in the natural state and the finger is positioned away from the kcy top 50, the capacitance Ct generated between the ground and the conductive member 32 is equal to the capacitance Cx generated between the conductive member 32 and the ground contact 15. In this case, the capacitance Cf generated by the finger is low and the ground contact 15 and the conductive member 32 are separated. Thus, in this case, as shown in FIG. 11, the capacitance Ct generated between the ground and the conductive member 32 is relatively low. At this time, since the high potential contact 14 is not electrically connected to the ground contact 15, the voltage at the high potential contact 14 is higher than a predetermined reference voltage Vref.

In a state in which the key assembly 1 is in the natural state, as a finger approaches the key top 50 (i.e., as the finger position moves to the right toward zero in FIG. 11), the capacitance Cf by the finger increases. The capacitance Ct generated between the ground and the conductive member 32 at this time is calculated by formula (1) above. Thus, as shown in FIG. 11, as the finger approaches the key top 50, the capacitance Ct generated between the ground and the conductive member 32 also increases.

Thereafter, as the finger contacts the key top 50 and the key top 50 is pressed down (and thus, as the finger position moves from zero to the right in FIG. 11), the distance between the ground contact 15 and the conductive member 32 gradually decreases. As a result, the capacitance Cx between the ground contact 15 and the conductive member 32 gradually increases. In particular, since the plate-like part 33 of the conductive member 32 is arranged so as to at least partially overlap the ground contact 15 when viewed in the upward-downward directions in the present embodiment, the capacitance Cx is likely to change with respect to the change in the distance between the ground contact 15 and the conductive member 32. Furthermore, as the key top 50 is pressed down, since the force with which the finger presses the key top 50 increases, the finger is compressed and the contact area of the finger with the key top 50 gradually increases, albeit slightly. As a result, as the key top 50 is pressed down, the capacitance Cf by the finger increases. The capacitance Ct generated between the ground and the conductive member 32 at this time is calculated by formula (1) above. Thus, as shown in FIG. 11, as the finger moves downward after contacting the key top 50, the capacitance Ct generated between the ground and the conductive member 32 also increases. However, the rate at which the capacitance Ct generated between the ground and the conductive member 32 increases in response to the movement of the finger at this time is slower than the rate at which the capacitance Ct increases in response to the movement of the finger when the finger approaches the key top 50.

Thereafter, when the key top 50 is pressed further and the conductor 25, which moves integrally with the key top 50, moves downward until it comes into contact with both contacts 14, 15 (i.e., when the finger position moves to de in FIG. 11), the conductor 25 comes into contact with both contacts 14, 15, and both contacts 14, 15 become conductive. Thus, at this time, the voltage at the high potential contact 14 becomes lower than the predetermined reference voltage Vref.

Furthermore, when the conductor 25 comes into contact with both contacts 14, 15 (and in particular, the ground contact 15), the capacitance C′x is generated between the conductor 25 and the conductive member 32. Since the surface area of the conductor 25 facing the conductive member 32 is larger than the surface area of the ground contact 15 facing the conductive member 32, and the distance to the conductive member 32 is reduced by the thickness of the conductor 25, when the conductor 25 comes into contact with the ground contact 15 (when the finger position reaches dc), the capacitance Ct generated between the ground and the conductive member 32 suddenly increases.

Thereafter, as the key top 50 is pressed downward after the conductor 25 comes into contact with the ground contact 15 (i.e., as the finger position moves from de to the right in FIG. 11), since the moving part 21 is compressed in the upward-downward directions, and the conductor 25 and the conductive member 32 approach each other, the capacitance C′x between the conductor 25 and the conductive member 32 gradually increases. In particular, since the plate-like part 33 of the conductive member 32 is arranged so as to at least partially overlap the conductor 25 when viewed in the upward-downward directions in the present embodiment, the capacitance C′x changes relatively greatly when the distance between the conductor 25 and the conductive member 32 changes. Further, since the surface area of the conductor 25 is larger than that of the ground contact 15 as described above, the rate of increase of the capacitance Ct generated between the ground and the conductive member 32 in response to movement of the finger at this time is greater than the rate of increase before the conductor 25 comes into contact with the ground contact 15.

### Information Processing System

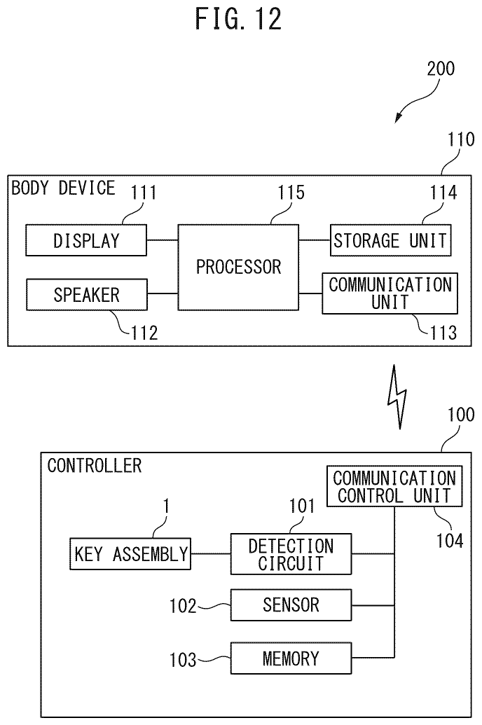

Next, a controller 100 including the key assembly 1 and an information processing system 200 including the controller 100 and a body device 110 will be described with reference to FIG. 12. FIG. 12 is a view schematically showing the system configuration of the information processing system 200 including the controller 100.

The controller 100 is used to perform various operations associated with information processing. The controller 100 is, for example, a game controller used to operate a game. However, the controller 100 may also be an information processing controller used to perform operations such as moving a cursor and selecting a menu. As shown in FIG. 12, the controller 100 includes the key assembly 1, the detection circuit 101, a sensor 102, a storage unit 103, and a communication control unit 104. The detection circuit 101, the sensor 102, and the storage unit 103 are all connected to the communication control unit 104.

The detection circuit 101 detects the capacitance between the ground and the conductive member 32 of the key assembly 1, and detects the voltage at the high potential contact 14 in the key assembly 1. For example, the detection circuit 101 periodically charges between the ground and the conductive member 32, and detects the capacitance between the ground and the conductive member 32 based on the time until full charge at this time or the current flowing during charging. Thus, the capacitance detected by the detection circuit 101 changes in accordance with the distance between the ground contact 15 and the conductive member 32 until the conductor 25 contacts the ground contact 15. Furthermore, after the conductor 25 contacts the ground contact 15, the capacitance detected by the detection circuit 101 changes in accordance with the distance between the conductor 25 in contact with the ground contact 15 and the conductive member 32. The detection circuit 101 detects the voltage at the high potential contact 14 to be used for determining the continuity between the contacts 14, 15. The detection circuit 101 outputs a signal which changes in accordance with the capacitance between the ground and the conductive member 32 and a signal which changes in accordance with the voltage at the high potential contact 14, and the output signals are input to the communication control unit 104.

As described above, the capacitance between the ground and the conductive member 32 indicates the degree to which the finger of a user or the like approaches the key assembly 1 or the degree to which the key assembly 1 is pressed. Thus, the detection circuit 101 can detect the capacitance indicating the degree to which the finger of a user or the like approaches the key assembly 1 or the degree to which the key assembly 1 is pressed. Furthermore, the voltage at the high potential contact 14 indicates whether or not the user has pressed the key assembly 1. Thus, the detection circuit 101 of the present embodiment can detect the value of a parameter which changes in accordance with whether or not the key assembly 1 is pressed. Note that in the present embodiment, the voltage at the high potential contact 14 is used as the parameter which changes in accordance with whether or not the key assembly 1 is pressed, but other parameters, such as the current flowing through the high potential contact 14, may be used as long as they change in accordance with whether or not the key assembly 1 is pressed.

The sensor 102 detects the state of the controller 100. The sensor 102 includes, for example, an acceleration sensor and an angular velocity sensor. Output signals of the sensor 102 are input to the communication control unit 104.

The communication control unit 104 communicates with the body device 110 by wireless communication. The communication control unit 104 acquires information (for example, information regarding the operation of the key assembly 1, or the result of detection by the sensor 102) from each input unit (such as the detection circuit 101 connected to the key assembly 1, the sensor 102, etc.). Furthermore, the communication control unit 104 transmits data including the acquired information (or information obtained by performing a predetermined process on the acquired information) to the body device 110. The communication control unit 104 is constituted by, for example, a microprocessor. The communication control unit 104 executes various processes by executing firmware stored in the storage unit 103. Note that the communication control unit 104 may communicate with the body device 110 by wired communication instead of or in addition to wireless communication.

As shown in FIG. 12, the body device 110 includes a display 111, a speaker 112, a communication unit 113, a storage unit 114, and a processor 115. The display 111, the speaker 112, the communication unit 113, and the storage unit 114 are electrically connected to the processor 115.

The display 111 and the speaker 112 are examples of output devices for outputting information to a user. The display 111 displays images based on commands from the processor 115. The speaker 112 generates sound based on commands from the processor 115.

The communication unit 113 is a device for communicating with other devices (for example, the controller 100) via wireless communication. Note that the communication unit 113 may be configured so as to be capable of communicating with other devices via wired communication instead of or in addition to wireless communication.

The storage unit 114 includes, for example, volatile semiconductor memory, non-volatile semiconductor memory, etc. The storage unit 114 may further include a storage medium such as a hard disk drive (HDD), a solid-state drive (SSD), etc. The storage unit 114 stores computer programs which are executed by the processor 115, and various data which is used when various processes are executed by the processor 115.

The processor 115 includes one or more central processing units (CPUs) and peripheral circuits therefor. The processor 115 executes various information processing by executing information processing programs stored in the storage unit 114. The information processing programs include, for example, an OS program and an application program (for example, a game program).

In particular, in the present embodiment, the processor 115 performs processing in accordance with an information processing program based on the signal output from the detection circuit 101. For example, the processor 115 may perform processing based on the signal which changes in accordance with the capacitance output from the detection circuit 101. The signal which changes in accordance with the capacitance output from the detection circuit 101 represents the degree to which the finger of a user or the like, approaches the key assembly 1, the degree to which the key assembly 1 is pressed, etc. Thus, the processor 115 performs processing based on the degree to which the finger of a user or the like approaches the key assembly 1, and the degree to which the key assembly 1 is pressed.

Further, the processor 115 calculates a change in the capacitance which changes in accordance with the distance between the ground contact 15 and the conductive member 32 or the distance between the conductor 25 in contact with the ground contact 15 and the conductive member 32, based on the signal which changes in accordance with the capacitance output from the detection circuit 101. The processor 115 may perform processing based on the change in the capacitance calculated in this manner. Such a change in capacitance represents the degree to which the finger of a user or the like approaches the key assembly 1, the degree to which the key assembly 1 is pressed and moved, etc. Thus, the processor 115 performs processing based on the degree to which the finger of a user or the like approaches the key assembly 1, and the degree to which the key assembly 1 is pressed and moved. In particular, the change in capacitance which changes in accordance with the distance between the conductor 25 in contact with the ground contact 15 and the conductive member 32 represents a change in the amount of pressing of the key assembly I by the user after the pressing of the key assembly 1 by the user is detected. Thus, the processor 115 performs processing based on the change in the amount of depression of the key assembly 1 by the user after the depression of the key assembly 1 by the user is detected.

The processor 115 determines whether or not the user has pressed the key assembly 1 based on the signal which changes in accordance with the voltage output from the detection circuit 101. The processor may then perform processing based on the result of the determination of whether or not the key assembly 1 has been pressed.

The processor 115 then outputs the results of the processing to output devices such as the display 111 and the speaker 112. Thus, the display 111 and the speaker 112 output the results of the processing performed by the processor 115 based on the signal which changes in accordance with the capacitance and the signal which changes in accordance with the voltage, output from the detection circuit 101 of the key assembly 1.

In this manner, the processor 115 can perform processing based not only on whether or not the user has pressed key assembly 1, but also on the degree to which the finger of a user or the like approaches the key assembly 1 and the degree to which the key assembly 1 is pressed, allowing for a wider variety of processing than the case in which processing is based only on whether or not key assembly 1 is pressed.

In the present embodiment, the controller 100 is provided with a detection circuit 101, which outputs a signal which changes in accordance with the capacitance between the ground and the conductive member 32 and a signal which changes in accordance with the voltage at the high potential contact 14. However, such a detection circuit 101 may be provided in the body device 110 instead of the controller 100. In this case, the controller 100 communicates with the body device 110 via, for example, a wire, and the detection circuit of the body device 110 is directly electrically connected to the key assembly 1. Alternatively, a processor may be provided in the controller 100. In this case, the processor provided in the controller 100 may calculate the change in capacitance based on the signal which changes in accordance with the capacitance, and may also determine whether or not the key assembly 1 has been pressed by a user.

In the present embodiment, the body device 110 includes output devices such as a display and a speaker, and the processing results by the processor 115 of the body device 110 are output from these output devices. However, the body device 110 may output the processing results to an external output device (such as an external display, speaker, or controller). Furthermore, the body device 110 may be a server which communicates with the controller 100.

### Effects

In the key assembly 1 according to the present embodiment, when a user operates the key assembly 1 to move the key top 50 and the moving part 21 of the elastic member 20 downward, the conductor 25 comes into contact with the contacts 14, 15, and the contacts 14, 15 become conductive. Thus, by determining whether the contacts 14, 15 are conductive, it is possible to detect whether the user has pressed the key assembly 1.

Furthermore, the conductive assembly 30 electrically connected to the electrodes of the substrate 10 extends to the moving part upper surface 23. Thus, when a finger of a user approaches the key top 50 to operate the key assembly 1, and specifically, when the finger of the user approaches the moving part upper surface 23, the distance between the finger of the user and the conductive assembly 30 changes, and the capacitance generated therebetween changes. As a result, the approach or contact of the finger of a user to the key assembly I can be detected based on the capacitance or based on the change in capacitance.

In the present embodiment, the conductive assembly 30 extends through the through hole 26 provided in the moving part 21, and the conductor 25 is arranged around the through hole 26. Thus, the structure of the key assembly I can be simplified as compared to the case in which the conductive assembly 30 is arranged around the outer periphery of the moving part 21 or the conductor 25. Thus, according to the present embodiment, a key assembly 1 having a simple structure which can detect not only whether the key assembly 1 is pressed but also whether an object such as a finger of a user approaches or comes into contact with the key assembly I can be provided.

In the key assembly 1 according to the present embodiment, the conductive member 32, i.e., the upper end of the conductive assembly 30, is biased upward by the coil spring 31. By providing an elastic member such as the coil spring 31 in this manner, the coil spring 31 can maintain contact with the conductive member 32 even if the conductive member 32 moves in conjunction with the movement of the moving part 21. Thus, by providing such an elastic member, disconnection of the connection between the conductive member 32 and the electrode 13, i.e., the connection between the conductive assembly 30 and the electrode 13, can be prevented.

In the present embodiment, since the electrode 13 and the conductive member 32 are connected by a coil spring, which is an elastic member, the shape change which occurs when the moving part 21 and the conductive member 32 move can be predicted. Thus, by appropriately arranging the elastic member and other surrounding components, the occurrence of connection failures and the like caused by interference, such as the elastic member becoming entangled with other components, due to the movement of the moving part 21, can be prevented.

In the key assembly 1 according to the present embodiment, the plate-like part 33 of the conductive member 32 is formed so as to at least partially cover the moving part upper surface 23. By positioning the conductive member 32 not only in the through hole 26 of the moving part 21 but also on the moving part upper surface 23 in this manner, even if an object such as a finger of a user is positioned laterally deviated from the through hole 26, the capacitance is likely to change in accordance with the distance between the conductive member 32 and the object, and thus, the approach or contact of the object to the key top 50 can easily be detected. Since the conductive member 32 including the plate-like part 33 is formed of a rigid material, even if the key top 50 is pushed down by a finger or the like off the axis X, the entire moving part 21 can be moved downward relatively uniformly.

Furthermore, in the key assembly 1 according to the present embodiment, the conductor 25 extends around the entirety of the circumference so as to surround the through hole 26. Thus, the area of overlap between the conductor 25 and the plate-like part 33 of the conductive member 32 when viewed in the upward-downward directions can be made larger than the case in which the conductor 25 is formed so as to extend partially in the circumferential direction. As a result, the amount of change in the capacitance C′x relative to the change in the distance between the conductor 25 and the conductive member 32 can be made larger, making it easier to detect the change in the distance between the conductor 25 and the conductive member 32. In addition, since the conductor 25 is formed so as to extend around the entirety of the circumference so as to surround the through hole 26, and the contacts 14, 15 of the substrate 10 are both positioned radially inward and radially outward in an annular manner, the contacts 14, 15 can be made conductive even if the conductor 25 is slightly inclined in any direction when it moves downward and only a part thereof comes into contact with the contacts 14, 15.

In the present embodiment, at least one of the adhesive 40 and the key top 50 is formed of a non-conductive material. Thus, even if an object such as a human finger touches the key top 50, there is no direct electrical connection between the conductive member 32 and the object. If there is direct electrical connection between the conductive member 32 and the object, the capacitance between the ground and the conductive member 32 changes significantly, and thus, a detection circuit 101 with a large dynamic range is required. In contrast, in the present embodiment, since there is no direct electrical connection between the conductive member 32 and the object, the capacitance can be detected even by the detection circuit 101 with a relatively small dynamic range.

### Modification Examples

In the embodiment described above, the conductive member 32 includes the plate-like part 33, which covers the moving part upper surface 23. However, as long as the conductive assembly 30 extends through the through hole 26 of the moving part 21 to the moving part upper surface 23, the conductive member 32 need not include the plate-like part 33. Alternatively, the conductive member 32 may include a non-plate-like member which covers the moving part upper surface 23, such as a mesh-like member.

In the embodiment described above, the intermediate part 34 of the conductive member 32 is formed so as to fit into the through hole 26. However, as long as the conductive assembly 30 extends within the through hole 26 to the moving part upper surface 23 even if the moving part 21 moves in the upward-downward directions, the intermediate part 34 need not fit into the through hole 26.

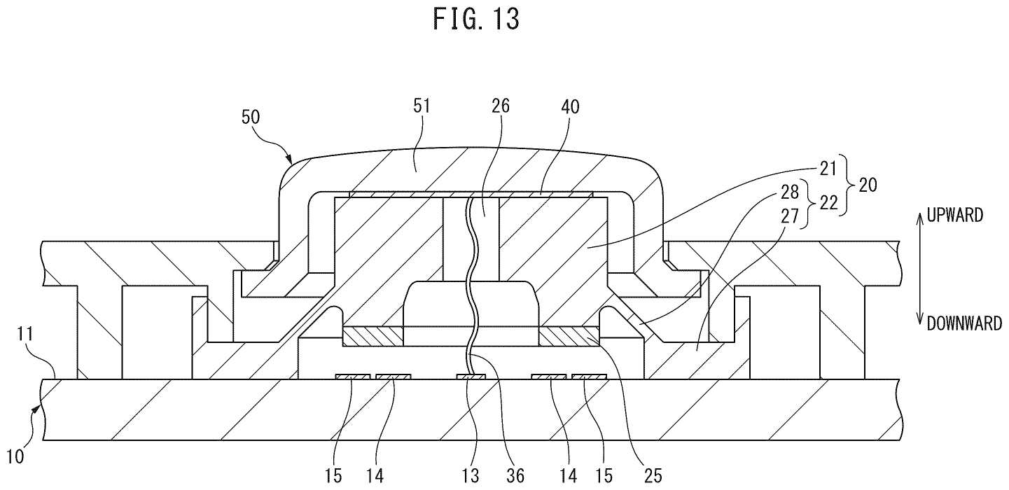

Furthermore, in the present embodiment, the conductive assembly 30 includes the coil spring 31 and the conductive member 32, but the conductive assembly 30 may not include the coil spring 31 and the conductive member 32 as long as the conductive assembly 30 is connected to the electrode 13 and extends to the moving part upper surface 23 through the through hole 26 regardless of the clearance between the key top 50 and the substrate 10. FIG. 13 is a cross-sectional view similar to FIG. 1, of a key assembly 1 according to one modification. As shown in FIG. 13, the conductive assembly 30 may be a conductor wire 36 or an FPC connected to the electrode 13 and bonded to the lower surface of the upper wall 51 of the key top 50. Alternatively, the conductive assembly 30 may include a coil spring which extends to the moving part upper surface 23 without the conductive member 32.

Furthermore, in the embodiment described above, the moving part 21 is formed so as to solid except for the through hole 26. However, the part of the moving part 21 except for the through hole 26 may be formed so as to be hollow or porous. Specifically, for example, the moving part 21 may be formed of urethane foam. By forming the moving part 21 hollow or porous in this manner, it becomes easier for the user to compress the moving part 21 in the upward-downward directions. Furthermore, in the embodiment described above, the moving part 21 is formed of an elastic material. However, the moving part 21 may be formed of a rigid material.

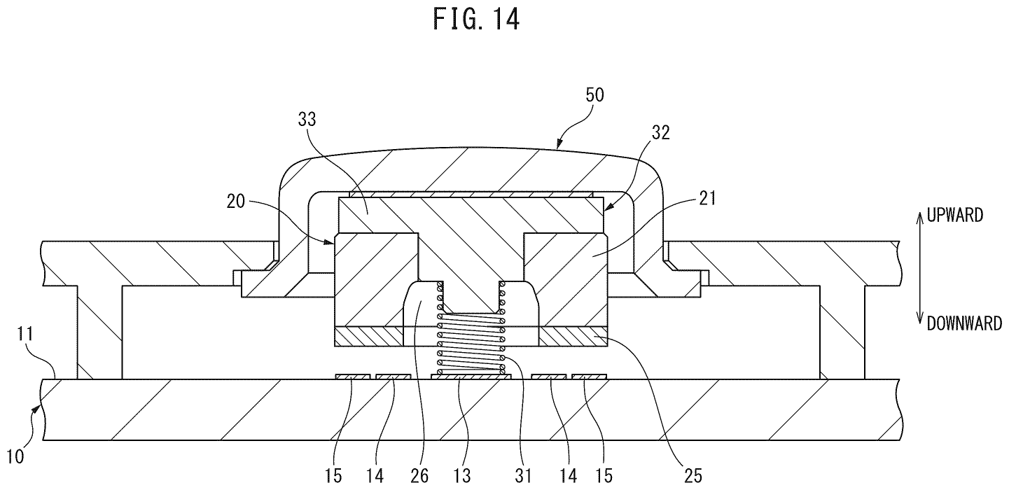

In the embodiment described above, the elastic member 20 includes the moving part 21 and the biasing part 22. However, the elastic member 20 may not include the biasing part 22. FIG. 14 is a cross-sectional view of a key assembly 1 according to a modification similar to FIG. 1. In the example shown in FIG. 14, the elastic member 20 includes only the moving part 21 without the biasing part 22. However, even in this case, the moving part 21 is biased upward together with the conductive member 32 by the coil spring 31. In the example shown in FIG. 14, the moving part 21 may be a member which is not elastic. In this case, since the moving part 21 does not clastically deform when the conductor 25 contacts the contacts 14, 15, the key top 50 and the conductive member 32 cannot be pressed further. Thus, in this case, the change in capacitance or the like, which represents the change in the amount of pressing of the key assembly 1 by the user after the pressing of the key assembly 1 is detected, need not be calculated.

In the embodiment described above, both the adhesive 40 and the key top 50 are formed of a non-conductive material. However, either one of the adhesive 40 and the key top 50 may be formed of a conductive material, and the other may be formed of a non-conductive material. Thus, the adhesive 40 may be formed of a non-conductive material, and the key top 50 may be formed of a conductive material. In this case, when an object such as a finger contacts the key top 50, since the distance between the conductive key top 50 contacting the object and the conductive member 32 is short, the capacitance generated between the object and the conductive member 32 at this time can be high. Alternatively, both the adhesive 40 and the key top 50 may be formed of a conductive material. In this case, when an object such as a finger contacts the key top 50, the capacitance Cf caused by the finger in FIG. 7 disappears, and the capacitance Ct generated between the ground and the conductive member 32 increases rapidly.

In the embodiment described above, the key assembly 1 is generally circular and includes a set of the electrode 13 and the contacts 14, 15. However, the key assembly 1 may be generally rectangular or have a shape other than a circle. The key assembly 1 may also be used in a cross key or the like. In this case, for example, an assembly which includes the electrode 13, the contacts 14, 15, the elastic member 20, the conductive assembly 30, and the adhesive 40 is provided at each of the four ends of the cross key.

Though the preferred embodiments of the present invention have been described above, the present invention is not limited to these embodiments, and various modifications and changes can be made within the scope described in the claims.

1. A key assembly, comprising:
a substrate comprising an electrode and at least two contacts on an upper surface, which is a surface on a first direction side, thereof;
a moving part which is arranged on the first direction side of the substrate and which is non-conductive; and
a first conductor which is electrically connected to the electrode, wherein
the moving part comprises a first surface which is spaced from and faces the upper surface of the substrate in a natural state, a second surface which is provided on a side opposite of the first surface, and a through hole which penetrates the moving part in the first direction between the first surface and the second surface,
a second conductor is provided on the first surface of the moving part at a position which contacts the at least two contacts simultaneously in response to a movement of the moving part from the natural state in a second direction opposite to the first direction, and
the first conductor extends to the second surface through the through hole.

2. The key assembly according to claim 1, wherein the first conductor comprises an elastic member which biases an end of the first conductor on the second direction side in the first direction.

3. The key assembly according to claim 1, wherein the first conductor covers the second surface of the moving part.

4. The key assembly according to claim 3, wherein the first conductor covers an entirety of the second surface of the moving part.

5. The key assembly according to claim 3, wherein the first conductor comprises an upper body which covers the second surface and which is rigid.

6. The key assembly according to claim 5, wherein the first conductor comprises a lower body which is provided between the substrate and the upper body and which biases the upper body in the first direction.

7. The key assembly according to claim 6, wherein the upper body is partially positioned in the through hole of the moving part.

8. The key assembly according to claim 7, wherein a portion of the upper body which is positioned in the through hole is in radial contact with an inner surface of the moving part, which defines the through hole.

9. The key assembly according to claim 8, wherein the lower body is a coil spring and is arranged so as to surround a periphery of a portion of the upper body on the second direction side more than a portion of the upper body in contact with the inner surface of the moving part.

10. The key assembly according to claim 6, further comprising an elastic member which comprises the moving part and a biasing part which biases the moving part in the first direction toward a position in the natural state when the moving part moves from the natural state in the second direction, wherein
when the moving part moves from the natural state in the second direction, a force by which the biasing part biases the moving part in the first direction is greater than a force by which the lower body biases the upper body in the first direction.

11. The key assembly according to claim 3, wherein at least one of the at least contacts is connected to a ground, and
the moving part is formed such that a distance between the first surface and the second surface decreases as a pressing force increases when the first conductor is pressed in the second direction after the second conductor has come into contact with the at least two contacts.

12. The key assembly according to claim 11, wherein at least one of the at least two contacts is connected to a ground, and
the first conductor is arranged on the first direction side of the second conductor so as to at least partially overlap the second conductor when viewed in the first direction.

13. The key assembly according to claim 1, wherein the second conductor extends so as to surround the through hole.

14. The key assembly according to claim 12, wherein two of the contacts are provided on the substrate, and two of the contacts are arranged so as to be co-annular and positioned radially inward and radially outward relative to each other.

15. The key assembly according to claim 1, further comprising a key top which is provided further on the first direction side than the moving part and the first conductor, wherein
the key top is adhered to a surface of the first conductor on the first direction side via an adhesive, and at least one of the key top and the adhesive is non-conductive.

16. The key assembly according to claim 1, wherein one of the two contacts is connected to a ground, and
the first conductor is arranged on a first direction side of the contact which is connected to the ground so as to at least partially overlap the contact which is connected to the ground when viewed in the first direction.

17. A controller, comprising the key assembly according to claim 1, and a detection circuit, wherein
the detection circuit is configured so as to be capable of detecting a value of a parameter which changes in accordance with a presence or absence of current between the contacts and a capacitance of a circuit including the electrode.

18. A controller, comprising the key assembly according to claim 11 and a detection circuit, wherein
the detection circuit is configured so as to be capable of detecting a capacitance which changes in accordance with a distance between the second conductor, which is in contact with the contact which is connected to the ground, and the first conductor.

19. An information processing system, comprising the key assembly according to claim 1, and one or a plurality of processors, wherein
the processors perform processing based on a value of a parameter which changes in accordance with a presence or absence of current between the contacts and a capacitance of a circuit including the electrode.
